(19) United States
(12) Patent Application Publication
(10) Pub. No.: US 2010/0290130 A1
(43) Pub. Date: Nov. 18, 2010

(54) IMAGING LENS SYSTEM AND IMAGING APPARATUS USING THE SAME

(75) Inventor: Yoshiki Okamoto, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/863,826

(22) PCT Filed: Jan. 20, 2009
(86) PCT No.: PCT/JP2009/050714

§ 371 Date: Jul. 21, 2010

(30) Foreign Application Priority Data
Feb. 4, 2008 (JP) P2008-024217

(51) Int. Cl. G02B 15/14

(52) U.S. Cl. 359/683

(57) ABSTRACT

An imaging lens system has an autofocus function using a liquid lens and an imaging apparatus using the imaging lens system in which the imaging lens system is configured with a smaller number of lenses to facilitate downsizing. The imaging lens system includes a first lens group and a second lens group in this order from the object side. The second lens group includes a liquid lens system in which the curvature radius of the interface between a conductive liquid and an insulating liquid changes depending on an applied voltage. The curvature center of the interface between the conductive liquid and the insulating liquid of the liquid lens system is shifted toward the conductive liquid.

### CROSS REFERENCE TO RELATED APPLICATIONS

The present application is a National Stage of International Application No. PCT/JP2009/050714 filed on Jan. 20, 2009, and which claims priority to Japanese Patent Application No. 2008-024217 filed on Feb. 4, 2008, the entire contents of which are being incorporated herein by reference.

### BACKGROUND

The present disclosure relates to an imaging lens system having an autofocus function and an imaging apparatus using the imaging lens system.

As an electrowetting device using electrowetting, variable-focus lens devices using a liquid lens have been introduced by Varioptic (France) and Philips (Netherlands) (for example, see Non-patent Document 1).

Also, imaging lens systems having an autofocus function by similarly using a liquid lens have been proposed (for example, see Patent Documents 1 and 2).

The imaging lens system proposed in Patent Document 1 includes four lens groups, in which a first lens group on the object side includes a liquid lens.

On the other hand, the imaging lens system proposed in Patent Document 2 includes three lens groups, in which a first lens group also includes a liquid lens.

Non-patent Document 1: S. Kuiper et al., “Variable-focus liquid lens for miniature cameras”, Applied Physics Letters, Vol. 85, No. 7, 16 Aug. 2004, pp. 1128-1130

Patent Document 1: JP-A-2005-84387

Patent Document 2: JP-A-2006-72295

### SUMMARY

However, the imaging lens systems proposed in Patent Documents 1 and 2 include three or more lens groups, thereby including a large total number of lenses, which is a disadvantage in downsizing an imaging lens system and an imaging apparatus having the imaging lens system. Especially for providing an imaging apparatus to compact portable equipment such as a mobile phone, further reducing the number of lenses is necessary in order to develop an imaging lens system having a liquid lens for practical use.

In view of the above problem, it is desirable to provide an imaging lens system having an autofocus function using a liquid lens and an imaging apparatus using the imaging lens system, in which the imaging lens system is configured with a smaller number of lenses to facilitate downsizing.

In order to solve the above problem, an imaging lens system in accordance with an embodiment includes a first lens group and a second lens group in this order from the object side. The second lens group includes a liquid lens system in which the curvature radius of the interface between a conductive liquid and an insulating liquid changes depending on an applied voltage. The curvature center of the interface between the conductive liquid and the insulating liquid of the liquid lens system is shifted toward the conductive liquid.

In the imaging lens system in accordance with the invention, the liquid lens system desirably includes a light-transmissive substrate, the conductive liquid, the insulating liquid and a light-transmissive substrate disposed in this order from the object side.

An imaging apparatus in accordance with an embodiment includes the above-described imaging lens system. Accordingly, the imaging apparatus includes an imaging lens system, a stop and an imaging unit. The imaging lens system includes a first lens group and a second lens group in this order from the object side. The second lens group includes a liquid lens system in which the curvature radius of the interface between a conductive liquid and an insulating liquid changes depending on an applied voltage. The curvature center of the interface between the conductive liquid and the insulating liquid of the liquid lens system is shifted toward the conductive liquid.

As described above, an imaging lens system and an imaging apparatus using the imaging lens system in accordance with the embodiment includes a first lens group and a second lens group in this order from the object side. The second lens group includes a liquid lens system in which the curvature radius of the interface between a conductive liquid and an insulating liquid changes depending on an applied voltage. This configuration using the two lens groups can reduce the total number of lenses with respect to an imaging lens system using a conventional liquid lens, facilitating downsizing.

Also, the curvature center of the interface between the conductive liquid and the insulating liquid of the liquid lens system is shifted toward the conductive liquid, which can reduce the undercorrection of the chromatic aberration.

Further, in the imaging lens system in accordance with the embodiment, configuring the liquid lens system such that a light-transmissive substrate, the conductive liquid, the insulating liquid and a light-transmissive substrate are disposed in this order from the object side allows the spherical aberration, the astigmatism and the distortion aberration to be reduced to a practically acceptable level, as described later. Thus, the imaging lens system and the imaging apparatus having good properties can be provided.

According to the embodiment, an imaging lens system having an autofocus function using a liquid lens can be configured with a smaller number of lenses to facilitate downsizing.

Additional features and advantages are described herein, and will be apparent from, the following Detailed Description and the figures.

### BRIEF DESCRIPTION OF THE FIGURES

FIG. 1 A schematic configuration diagram of an imaging apparatus including an imaging lens system in accordance with an embodiment.

FIG. 2 A schematic configuration diagram of an imaging lens system in accordance with a first embodiment.

FIGS. 3A-3C showing the spherical aberration, the astigmatism and the distortion aberration for a first through third states of the imaging lens system in accordance with the first embodiment.

FIG. 4 A schematic configuration diagram of an imaging lens system in accordance with a second embodiment.

FIGS. 5A-5C showing the spherical aberration, the astigmatism and the distortion aberration for a first through third states of the imaging lens system in accordance with the second embodiment.

FIG. 6 A schematic configuration diagram of an imaging lens system in accordance with a third embodiment.

FIGS. 7A-7C showing the spherical aberration, the astigmatism and the distortion aberration for a first through third states of the imaging lens system in accordance with the third embodiment.

### DETAILED DESCRIPTION

An example of the best mode for carrying out an embodiment is described below, and it should be understood that the embodiment is not limited to the example.

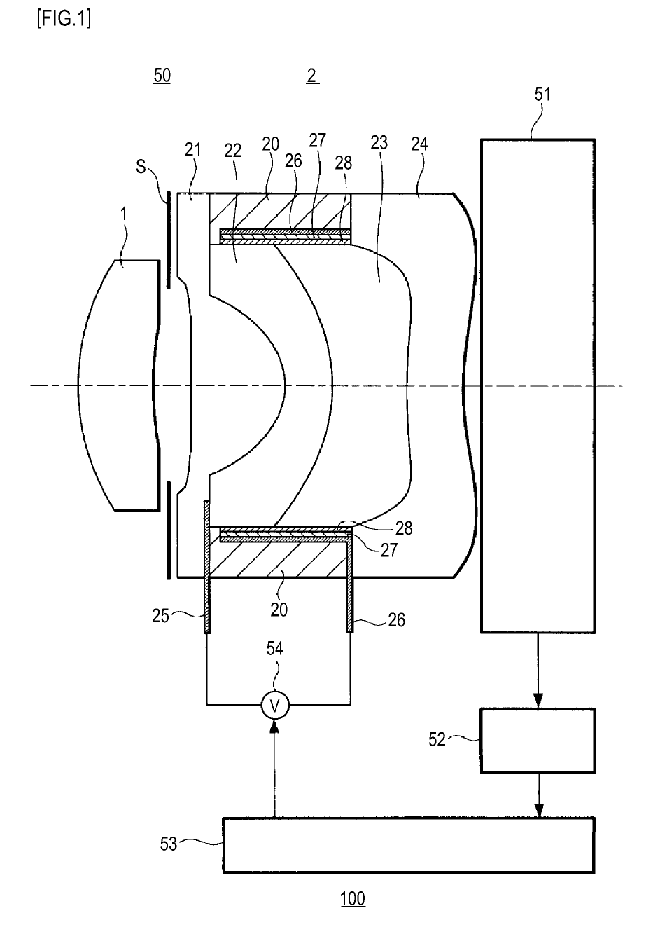

FIG. 1 shows a schematic configuration of an imaging lens system and an imaging apparatus using the imaging lens system in accordance with an embodiment. An imaging lens system 50 of an imaging apparatus 100 includes a first lens group 1 and a second lens group 2. For the second lens group 2, a variable-focus lens using a liquid lens system is used. The first lens group 1 may be configured with a single lens, for example, when both surfaces of the lens are aspheric. A stop S is disposed between the first lens group 1 and the second lens group 2, that is, on the object side with respect to the interface between a conductive liquid 22 and an insulating liquid 23 of the liquid lens system.

The liquid lens system used for the second lens group 2 of the imaging lens system 50 includes a light-transmissive substrate 21 disposed at an aperture on the object side of an enclosure 20 and a light-transmissive substrate 24 disposed at an aperture on the side opposite to the object side. The space enclosed by the enclosure 20 and the light-transmissive substrates 21, 24 is maintained liquid-tight. The shape of the enclosure 20 may be a shape rotationally symmetrical about an optical axis C, such as a cylinder or a cone with the top cut off. In the case shown in FIG. 1, the shape of the enclosure 20 is approximately a cylinder. The enclosure 20 contains the conductive liquid 22 and the insulating liquid 23 in this order from the object side. The enclosure 20 may be made of an insulating material. The light-transmissive substrates 21 and 24 may be made of a glass or a transparent resin such as plastic. On the other hand, the materials of the conductive liquid 22 and the insulating liquid 23 are light-transmissive, have different refraction indexes, and have the same density (specific gravity). The conductive liquid 22 may be made of an aqueous solution, such as salt water, that is not soluble in the insulating liquid 23. The insulating liquid 23 may be made of one or more of various oils such as silicone oil.

In the liquid lens system included in the second lens group 2 shown in FIG. 1, a first electrode 25 is formed at the aperture on the object side of the enclosure 20, in contact with the conductive liquid 22. A portion of the first electrode 25 is pulled out to be a terminal. Also, a second electrode 26 is formed cylindrically from the inner wall of the enclosure 20 to the aperture on the image side. A portion of the second electrode 26 is pulled out to be a terminal. An edge on the object side of the second electrode 26 extended on the inner wall of the enclosure 20 is formed separated from the first electrode 25 on the object side. Also, a dielectric film 27 and a water-repellent film 28 are provided on the surface of the second electrode 26 in the enclosure 20.

Also, the imaging apparatus 100 includes an imaging unit 51 disposed on the image side of the imaging lens system 50. The imaging unit 51 may be a charge-coupled device (CCD) or a complementary metal oxide semiconductor (CMOS) device or the like including: a plurality of photoelectric conversion sections for converting illuminated light energy to charge; a charge storage section for storing the charge; and a charge transfer section for transferring and sending out the charge. Further, the imaging apparatus 100 includes: a signal conversion unit 52 for converting the light signal detected by the imaging unit 51; a control unit 53 for processing signal; and a voltage application unit 54 for applying an voltage between the electrodes 25 and 26 of the second lens group 2 including the liquid lens system.

With this configuration, in the second lens group 2, when the voltage application unit 54 applies an appropriate voltage between the electrodes 25 and 26, the curvature of the interface between the conductive liquid 22 and the insulating liquid 23 will change. This change in the curvature can cause the lens effect on incident light to change, thereby changing the focal length.

Specifically, when no voltage is applied between the first and second electrodes 25 and 26, the interface between the conductive liquid 22 and the insulating liquid 23, filling the enclosure 20, forms a portion of a sphere with a certain radius due to the balance between the surface tensions of the liquids 22 and 23 and the inner wall surface of the enclosure 20.

When the voltage application unit 54 applies a voltage between the first and second electrodes 25 and 26, the conductive liquid 22 behaves as if its “wettability” to the inner wall surface of the enclosure 20 is improved (this phenomenon is called electrowetting), decreasing the contact angle. As a result, the curvature radius of the interface between the conductive liquid 22 and the insulating liquid 23 increases, causing the spherical surface to get closer to a flat surface.

Thus, the difference of refraction index and the curvature of the interface between the conductive liquid 22 and the insulating liquid 23 provide a lens effect, and the voltage application causes the curvature of the liquid interface to change due to electrowetting as above, thereby changing the focal length.

Advantageously, since the variable-focus lens using electrowetting as above essentially allows no current to flow except when discharging, it consumes very low power. Also advantageously, since this variable-focus lens has no mechanical moving part, it has a longer life than that of a conventional variable-focus lens in which a lens is moved by a motor or the like. Further, advantageously, since this variable-focus lens has no motor, it can provide an autofocus mechanism with a small footprint and simple configuration.

By the way, two liquids—insulating liquid (oil) and conductive liquid (water)—forming an liquid lens generally have the following relationship:

n1>n2, and

ν1<ν2,

where n1 and ν1 are the refraction index and Abbe's number of the insulating liquid, respectively, and n2 and ν2 are the refraction index and Abbe's number of the conductive liquid, respectively. Therefore, when the interface between the two liquids is convex toward the insulating liquid with the refraction index of n1, it has a positive power and a positive chromatic aberration. When the interface is concave toward the insulating liquid, it has a negative power and a negative chromatic aberration.

Generally, since the chromatic aberration of the entire optical system of an imaging apparatus tends to be undercorrected, it may be desirable that the interface between the two liquids is concave toward the insulating liquid.

Accordingly, when the second lens group 2 including the liquid lens system includes the light-transmissive substrate 21, the conductive liquid 22, the insulating liquid 23 and the light-transmissive substrate 24 disposed in this order from the object side, the curvature of the two-liquid interface is preferably concave toward the insulating liquid 23.

Thus, the imaging lens system 50 of this embodiment is configured such that the curvature center of the interface between the conductive liquid 22 and the insulating liquid 23 of the second lens group 2 is shifted toward the conductive liquid 22. This configuration causes the curvature of the interface between the two liquids to be concave toward the insulating liquid 23, which can reduce the undercorrection of the chromatic aberration of the entire imaging lens system 50.

Also, in this configuration, it is desirable that the liquid lens system of the second lens group 2 includes the conductive liquid 22 disposed on the object side and the insulating liquid 23 disposed on the image side, as shown in FIG. 1. This disposition allows the interface between the liquids 22 and 23 to be shifted toward the conductive liquid 22 when no voltage is applied.

Next, specific numerical examples of the imaging lens system in accordance with the embodiment are described below as a first through third embodiments. The following embodiments assume that both the first lens group 1 and the second lens group 2 have a positive power (refracting power).

### First Embodiment

First, a numerical example of a specific lens structure applicable as the first embodiment is described. This example is applied to the imaging lens system 50 of the imaging apparatus 100 described with reference to FIG. 1. The focal length f, the F-number Fno and the angle of view 2ω (ω is a half angle of view) of the imaging lens system 50 are as follows:

f=3.7 mm,

Fno=2.7, and

2ω=63°.

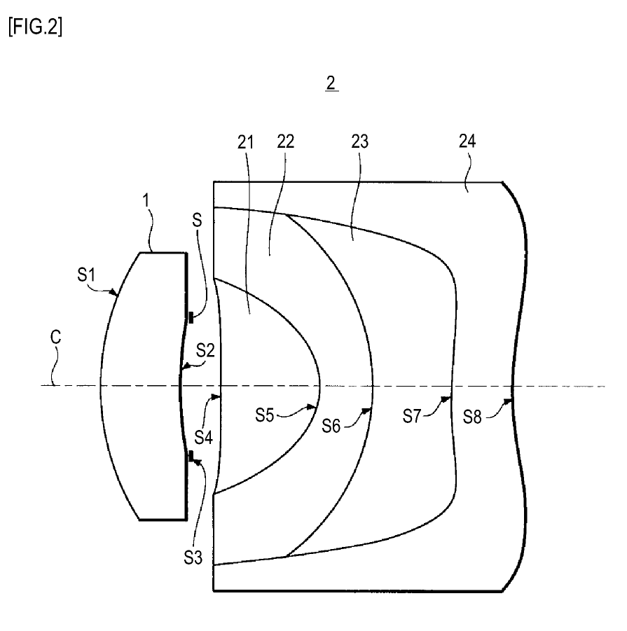

As shown in FIG. 2, the incidence and outgoing surface of the first lens group 1, the surface at which the stop S is disposed, and the incidence and outgoing surfaces of the light-transmissive substrate 21, the conductive liquid 22, the insulating liquid 23 and the light-transmissive substrate 24 of the second lens group 2 are denoted in the order from the object side as first through eighth surfaces S1 through S8. In FIG. 2, the parts described with reference to FIG. 1 are denoted by the same numerals, and will not be repeatedly described. Then, for each of the first through eighth surfaces S1 through S8, Table 1 below shows the curvature radius, the spacing along the optical axis between the surfaces (the distance to the next surface) (for the eighth surface S8, the distance to the surface of the imaging unit 51), the refraction index of d-ray of wavelength 587.56 nm for the medium between the surfaces and, similarly, the Abbe's number of d-ray, and others.

TABLE 1

| | | Spacing along | Refraction | | |
|---|---|---|---|---|---|
| | | optical axis | index | | |
| | Curvature | between | between | Abbe's | |
| Surface | radius r | surfaces | surfaces | number ν | |
| number | [mm] | d [mm] | n [d-ray] | [d-ray] | Type etc. |
| S1 | 2.121 | 0.800 | 1.5251 | 56.0 | Aspheric |
| S2 | 3.902 | 0.100 | — | — | Aspheric |
| S3 | Infinity | 0.300 | — | — | Aperture |
| | | | | | stop |
| S4 | 40.490 | 1.000 | 1.5251 | 56.0 | Aspheric |
| S5 | −0.601 | 0.500 | 1.3430 | 47.0 | Aspheric |
| S6 | R5 | 0.800 | 1.4982 | 34.6 | |
| S7 | 0.771 | 0.600 | 1.5251 | 56.0 | Aspheric |
| S8 | 2.991 | 0.200 | — | — | Aspheric |

Table 2 below shows aspherical coefficients of the first, second, fourth, fifth, seventh and eighth surfaces S1, S2, S4, S5, S7 and S8 when Eq. 1 below is used as aspherical surface equation. In Eq. 1, Z is the distance along the optical axis from the lens surface when the light traveling direction is a positive direction, h is the height perpendicular to the optical axis, R is the curvature radius, k is a conic constant, and A and B are 4th and 6th order aspherical coefficients, respectively.

$$Z = \frac{\frac{{h}^{2}}{R}}{1 + \sqrt{1 - ( 1 + k ) \frac{{h}^{2}}{{R}^{2}}}} + A {h}^{4} + {Bh}^{6} \qquad [ Eq . 1 ]$$

TABLE 2

| Surface number | k | A | B |
|---|---|---|---|
| S1 | −0.180850 | −0.112483 × 10⁻¹ | −0.361451 × 10⁻² |
| S2 | 6.915218 | −0.249712 × 10⁻¹ | −0.264184 × 10⁻¹ |
| S4 | −781.037146 | −0.551758 × 10⁻¹ | −0.950246 × 10⁻² |
| S5 | −1.066209 | 0.355959 × 10⁻¹ | −0.170921 |
| S7 | −3598.011318 | 0.140625 | −0.127323 |
| S8 | −16.914861 | −0.128842 × 10⁻¹ | −0.392521 × 10⁻² |

Table 3 below shows numerical examples of R5 of Table 1 above for object distances of 600, 120 and 50 mm in the first and second lens groups 1 and 2 shown in FIG. 2.

TABLE 3

| Object distance [mm] | R5 |
|---|---|
| 600 | −1.726 |
| 120 | −2.069 |
| 50 | −3.285 |

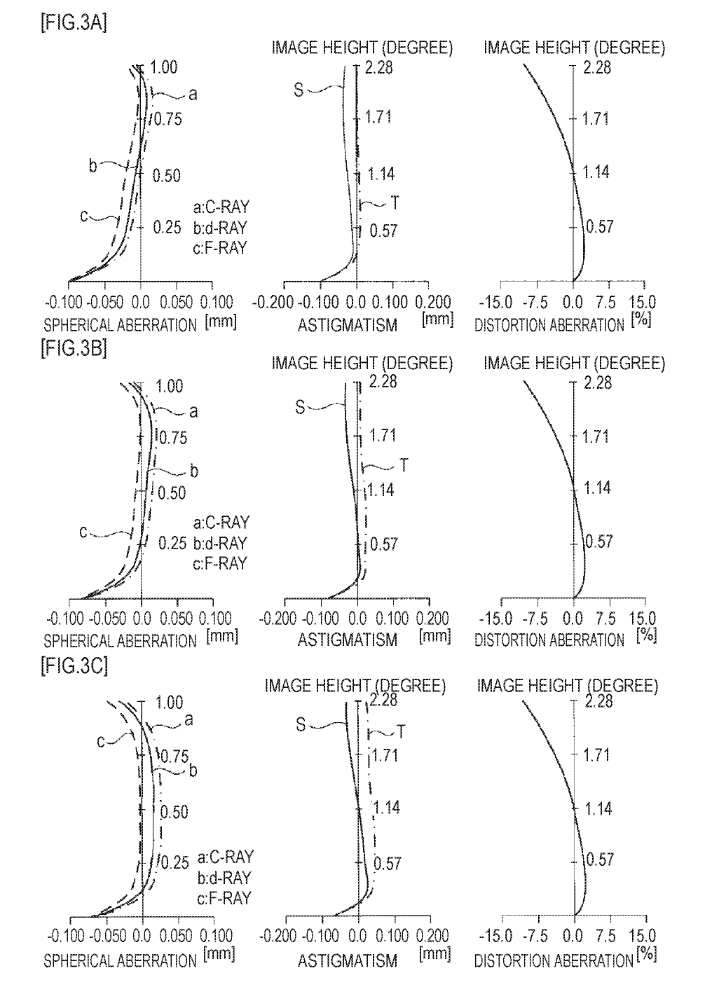

For the imaging lens system 50 configured with this numerical example, FIGS. 3A, 3B and 3C show the spherical aberration, the astigmatism and the distortion aberration for object distances of 600, 120 and 50 mm, respectively. In the graphs showing the spherical aberration of FIGS. 3A through 3C, the dashed-dotted line a indicates the spherical aberration of C-ray with a wavelength of 656.2700 nm, the solid line b indicates the spherical aberration of d-ray with a wavelength of 587.5600 nm, and the dashed line c indicates the spherical aberration of F-ray with a wavelength of 486.1300 nm.

In this case, as seen from FIGS. 3A through 3C, the spherical aberration, the astigmatism and the distortion aberration may be reduced to a practically acceptable level for any of these object distances. Also as seen from these figures, the differences of spherical aberration between these wavelengths of light may be sufficiently small, and the chromatic aberration may be reduced.

Thus, in the first embodiment, the practical imaging lens system 50 can be configured in which the aberrations are sufficiently reduced by the two lens groups. This can facilitate the downsizing of the imaging apparatus 100 including this imaging lens system 50.

### Second Embodiment

Next, a numerical example of a specific lens structure applicable as the second embodiment is described. This example is also applied to the imaging lens system 50 of the imaging apparatus 100 described with reference to FIG. 1. The focal length f, the F-number Fno and the angle of view 2ω (ω is a half angle of view) of the imaging lens system 50 are as follows:

f=3.7 mm,

Fno=2.7, and

2ω=63°.

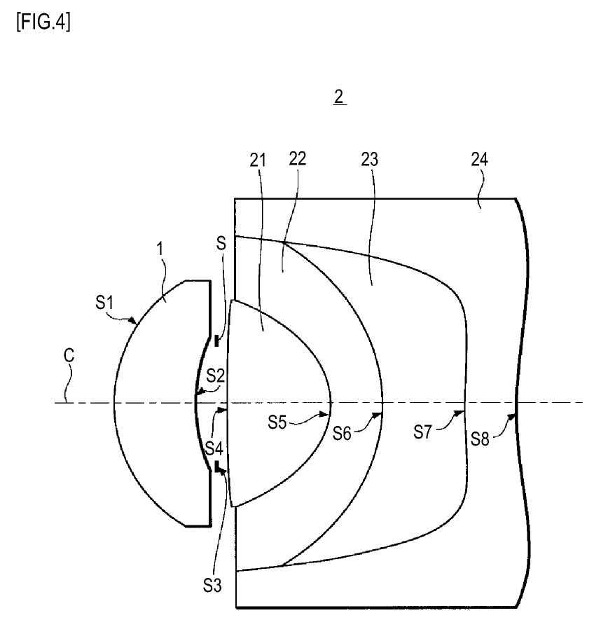

As shown in FIG. 4, the incidence and outgoing surface of the first lens group 1, the surface at which the stop S is disposed, and the incidence and outgoing surfaces of the second lens group 2 are denoted in the order from the object side as first through eighth surfaces 51 through S8. In FIG. 4, the parts described with reference to FIG. 1 are denoted by the same numerals, and will not be repeatedly described. For each of the first through eighth surfaces 51 through S8, Table 4 below shows the curvature radius, the spacing along the optical axis between the surfaces, the refraction index of d-ray for the medium between the surfaces and, similarly, the Abbe's number of d-ray, and others.

TABLE 4

| | | Spacing along | Refraction | | |
|---|---|---|---|---|---|
| | | optical axis | index | | |
| | Curvature | between | between | Abbe's | |
| Surface | radius r | surfaces | surfaces | number ν | |
| number | [mm] | d [mm] | n [d-ray] | [d-ray] | Type etc. |
| S1 | 1.487 | 0.800 | 1.5251 | 56.0 | Aspheric |
| S2 | 2.034 | 0.200 | — | — | Aspheric |
| S3 | Infinity | 0.100 | — | — | Aperture |
| | | | | | stop |
| S4 | 18.623 | 1.000 | 1.5251 | 56.0 | Aspheric |
| S5 | −0.652 | 0.500 | 1.3430 | 47.0 | Aspheric |
| S6 | −1.468 | 0.800 | 1.4982 | 34.6 | |
| S7 | 0.673 | 0.500 | 1.5251 | 56.0 | Aspheric |
| S8 | 3.775 | 0.200 | — | — | Aspheric |

Table 5 below shows aspherical coefficients of the first, second, fourth, fifth, seventh and eighth surfaces S1, S2, S4, S5, S7 and S8 when Eq. 1 above is used as aspherical surface equation.

TABLE 5

| Surface number | k | A | B |
|---|---|---|---|
| S1 | 0.288182 | −0.542391 × 10⁻² | 0.534802 × 10⁻² |
| S2 | 5.575642 | 0.243578 × 10⁻² | 0.550355 × 10⁻² |
| S4 | −262.904754 | −0.226503 × 10⁻¹ | 0.446056 × 10⁻¹ |
| S5 | −1.056883 | 0.149592 × 10⁻¹ | −0.164245 |
| S7 | −3598.011407 | 0.931462 × 10⁻¹ | −0.149786 |
| S8 | −15.398666 | −0.167286 × 10⁻¹ | −0.121115 × 10⁻² |

Table 6 below shows numerical examples of R5 of Table 4 above for object distances of 600, 120 and 50 mm in the first and second lens groups 1 and 2 shown in FIG. 4.

TABLE 6

| Object distance [mm] | R5 |
|---|---|
| 600 | −1.468 |
| 120 | −1.763 |
| 50 | −2.818 |

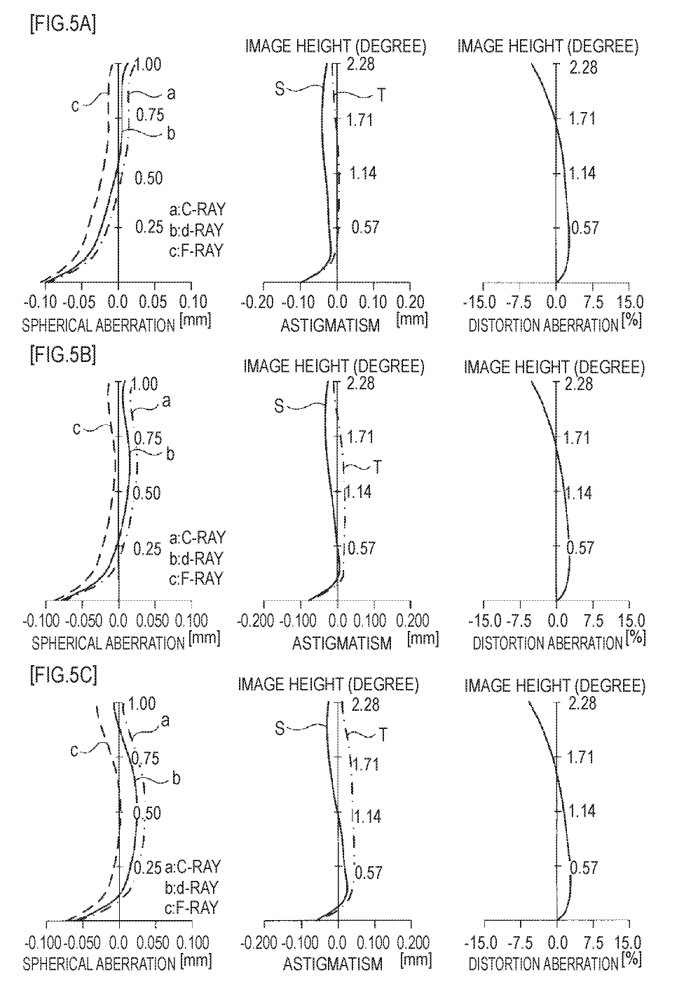

For the imaging lens system 50 configured with this numerical example, FIGS. 5A, 5B and 5C show the spherical aberration, the astigmatism and the distortion aberration for object distances of 600, 120 and 50 mm, respectively.

Again in this case, as seen from FIGS. 5A through 5C, the spherical aberration, the astigmatism and the distortion aberration may be reduced to a practically acceptable level for any of these object distances. Also as seen from these figures, the differences of spherical aberration between these wavelengths of light may be sufficiently small, and the chromatic aberration may be sufficiently reduced.

Thus, also in the second embodiment, the practical imaging lens system 50 can be configured in which the aberrations are sufficiently reduced by the two lens groups. This can facilitate the downsizing of the imaging apparatus 100 including this imaging lens system 50.

### Third Embodiment

Next, a numerical example of a specific lens structure applicable as the third embodiment is described. This example is also applied to the imaging lens system 50 of the imaging apparatus 100 described with reference to FIG. 1. The focal length f, the F-number Fno and the angle of view 2ω (ω is a half angle of view) of the imaging lens system 50 are as follows:

f=3.7 mm,

Fno=2.7, and

2ω=63°.

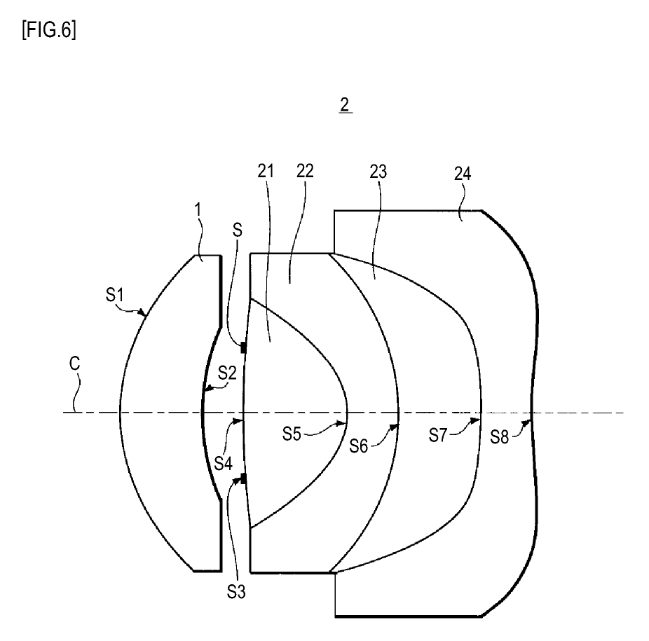

As shown in FIG. 6, the incidence and outgoing surface of the first lens group 1, the surface at which the stop S is disposed, and the incidence and outgoing surfaces of the second lens group 2 are denoted in the order from the object side as first through eighth surfaces S1 through S8. In FIG. 6, the parts described with reference to FIG. 1 are denoted by the same numerals, and will not be repeatedly described. For each of the first through eighth surfaces S1 through S8, Table 7 below shows the curvature radius, the spacing along the optical axis between the surfaces, the refraction index of d-ray for the medium between the surfaces and, similarly, the Abbe's number of d-ray, and others.

TABLE 7

| | | Spacing along | Refraction | | |
|---|---|---|---|---|---|
| | | optical axis | index | | |
| | Curvature | between | between | Abbe's | |
| Surface | radius r | surfaces | surfaces | number ν | |
| number | [mm] | d [mm] | n [d-ray] | [d-ray] | Type etc. |
| S1 | 1.856 | 0.800 | 1.5251 | 56.0 | Aspheric |
| S2 | 2.547 | 0.400 | — | — | Aspheric |
| S3 | Infinity | 0.000 | — | — | Aperture |
| | | | | | stop |
| S4 | 7.693 | 1.000 | 1.5251 | 56.0 | Aspheric |
| S5 | −0.659 | 0.500 | 1.3430 | 47.0 | Aspheric |
| S6 | −1.773 | 0.800 | 1.4982 | 34.6 | |
| S7 | −4.301 | 0.500 | 1.5251 | 56.0 | Aspheric |
| S8 | 4.739 | 0.100 | — | — | Aspheric |

Table 8 below shows aspherical coefficients of the first, second, fourth, fifth, seventh and eighth surfaces S1, S2, S4, S5, S7 and S8 when Eq. 1 above is used as aspherical surface equation.

TABLE 8

| Surface number | k | A | B |
|---|---|---|---|
| S1 | −0.288882 | −0.884378 × 10⁻² | — |
| S2 | 6.368048 | −0.462833 × 10⁻¹ | — |
| S4 | −161.278351 | — | — |
| S5 | −1.050802 | — | — |
| S7 | −3598.011734 | 0.221593 | — |
| S8 | −1.250619 | −0.567104 × 10⁻¹ | — |

Table 9 below shows numerical examples of R5 of Table 7 above for object distances of 600, 120 and 50 mm in the first and second lens groups 1 and 2 shown in FIG. 6.

TABLE 9

| Object distance [mm] | R5 |
|---|---|
| 600 | −1.77339 |
| 120 | −2.15242 |
| 50 | −3.52567 |

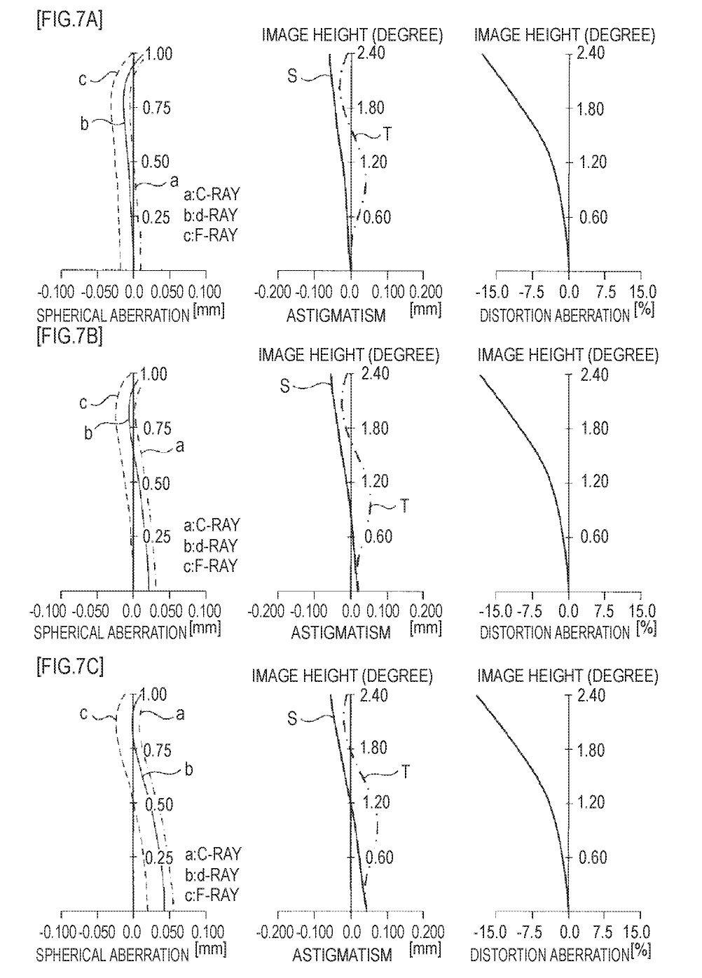

For the imaging lens system 50 configured with this numerical example, FIGS. 7A, 7B and 7C show the spherical aberration, the astigmatism and the distortion aberration for object distances of 600, 120 and 50 mm, respectively.

Again in this case, as seen from FIGS. 7A through 7C, the spherical aberration, the astigmatism and the distortion aberration may be reduced to a practically acceptable level for any of these object distances. Also as seen from these figures, the differences of spherical aberration between these wavelengths of light may be sufficiently small, and the chromatic aberration may be reduced.

Thus, also in the third embodiment, the practical imaging lens system 50 can be configured in which the aberrations are sufficiently reduced by the two lens groups. This can facilitate the downsizing of the imaging apparatus 100 including this imaging lens system 50.

As described above, according to the embodiment, by using only two lens groups, an imaging lens system having an autofocus function using a liquid lens and an imaging apparatus using the imaging lens system can be provided.

According to the embodiment, the curvature center of the interface between a conductive liquid and an insulating liquid in the liquid lens included in a second lens group on the image side is configured to be shifted toward the conductive liquid. This configuration causes the curvature of the interface between the two liquids to be concave toward the insulating liquid, which can reduce the undercorrection of the chromatic aberration of the entire imaging lens system.

Further, configuring the liquid lens system such that a light-transmissive substrate, the conductive liquid, the insulating liquid and a light-transmissive substrate are disposed in this order from the object side allows various aberrations to be reduced to a practically acceptable level, as described with respect to the above first through third embodiments.

Also, disposing a stop on the object side with respect to the position of the interface between the conductive liquid and the insulating liquid of the liquid lens system similarly allows the various aberrations to be sufficiently reduced.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-5. (canceled)

6. An imaging lens system comprising only a first lens group and a second lens group in this order from an object side,
wherein the second lens group includes a liquid lens system in which the curvature radius of the interface between a conductive liquid and an insulating liquid changes depending on an applied voltage,
wherein the liquid lens system includes a light-transmissive substrate, the conductive liquid, the insulating liquid and a light-transmissive substrate disposed in this order from the object side,
wherein the curvature center of the interface between the conductive liquid and the insulating liquid of the liquid lens system is shifted toward the conductive liquid, and
wherein the curvature center of the interface between the light-transmissive substrate and the conductive liquid is shifted toward the light-transmissive substrate.

7. The imaging lens system according to claim 6,
wherein a stop is disposed on the object side with respect to the position of the interface between the conductive liquid and the insulating liquid of the liquid lens system.

8. An imaging apparatus comprising an imaging lens system, a stop and an imaging unit,
wherein the imaging lens system includes only a first lens group and a second lens group in this order from the object side,
wherein the second lens group includes a liquid lens system in which the curvature radius of the interface between a conductive liquid and an insulating liquid changes depending on an applied voltage,
wherein the liquid lens system of the imaging lens system includes a light-transmissive substrate, the conductive liquid, the insulating liquid and a light-transmissive substrate disposed in this order from the object side, and
wherein the curvature center of the interface between the conductive liquid and the insulating liquid of the liquid lens system is shifted toward the conductive liquid, and the curvature center of the interface between the light-transmissive substrate and the conductive liquid is shifted toward the light-transmissive substrate.
